(19) United States
(12) Patent Application Publication
(10) Pub. No.: US 2014/0304807 A1
(43) Pub. Date: Oct. 9, 2014

(54) METHOD TO ACTIVATE AND RESTRICT CONTROL OF A DEVICE

(71) Applicant: DEETECTEE MICROSYSTEMS INC., Victoria (CA)

(72) Inventor: Edwin BRAUN, Victoria (CA)

(73) Assignee: DEETECTEE MICROSYSTEMS INC., Victoria (CA)

(21) Appl. No.: 14/244,212

(22) Filed: Apr. 3, 2014

Related U.S. Application Data
(60) Provisional application No. 61/810,189, filed on Apr. 9, 2013.

(51) Int. Cl. G06F 21/44

(52) U.S. Cl. CPC G06F 21/44
USPC 726/17

(57) ABSTRACT

There is provided a method to activate and restict control of a device. A first step involves positioning a secondary device on a human body which generates an authorization key. A second step involves using the human body as a local transmitter to transmit the authorization key from the secondary device to the device which is to be activated and controlled.

### FIELD

There is described a method of restricting control of a device. This method was developed to restrict access to stolen smart phones and portable computers, but has broader application.

### BACKGROUND

There is a “black market” in stolen smart phones and portable computers. If a method were available to render those devices useless to anyone other than the owner, there would he no motivation to steal such devices. Furthermore, even if such devices were stolen, there would not be as much concern regarding the information to which the thief could potentially have access.

### SUMMARY

There is provided a method to activate and restrict control of a device. A first step involves positioning a secondary device on a human body which generates an authorization key. A second step involves using the human body as a local transmitter to transmit the authorization key from the secondary device to the device which is to be activated and controlled.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a front elevation view of a first implementation of the method with a smart phone.

FIG. 2 is a front elevation view of a second implementation of the method with a smart phone.

### DETAILED DESCRIPTION

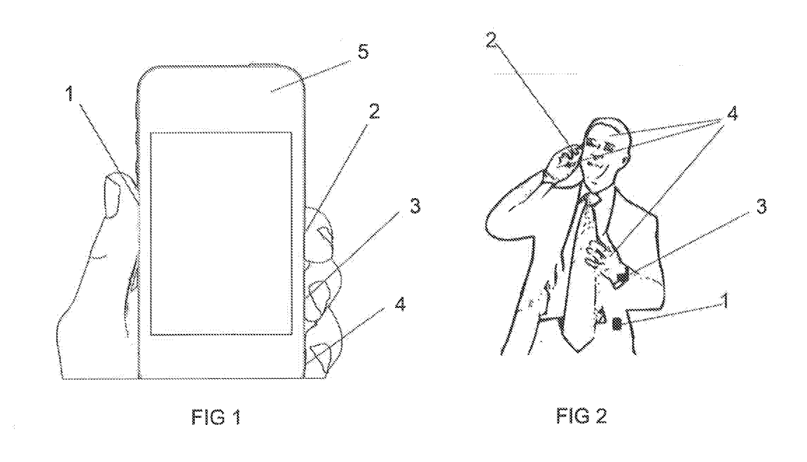

A method to activate and restrict control of a device will now be described with reference to FIG. 1 and FIG. 2.

The aforementioned invention is based on at least 2 Devices and the human body as a conductor
a) Software and Receiver in a hand held device (e.g. smart-phone) (FIG. 1/1)
b) A secondary device (the emitter FIG. 2-3 and FIG. 2-1) that either has contact to the human skin or is able to transmit contact less a signal through the human body..
c) The human body acting as transmitter (FIG. 2-4)

To operate and activate a hand held or mobile device of a legitimate user; a software program along with a receiver technology inside the hand held device scans for an encrypted authorization signal of the secondary device (b) that sends a signal through the human body, This signal can either consist of a
a) binary On/Off signal
b) a sequence of characters that are unique to the user and emitter

The hand held device is unlocked or allowed to operate with only when the aforementioned signal is detected. This unlocking can either he automatic or secured with another level of security measures (e.g. password)

By using the human body as a transmitter of the encrypted signal the hand held device needs to be touched by or held in hand and the second emitter device needs to be in close proximity to the human body/skin (transmitter on a key chain FIG. 2-1).

In one embodiment the emitter could be integrated in a watch (FIG. 2-3) or other similar type of wearable object that is usually worn close to the human body. This method ensures a natural and automatic authorization of the hand held or mobile device without the need of using or remembering complex pass codes or other means of security measures. The mobile device will not operate when other individuals will use it (hold it in their hands). Each mobile device will only operate in pair with its secondary key-device with the signal transmitted through the human body. The hand held device will only be operable by the authorized human owner.

In another embodiment of this method and system to activate and restrict control of a mobile device; the already existing and commonly used key-less car operation based on existing radio frequency proximity methods can be much more enhanced and secured. Existing key-less operation systems require only the key to be in close proximity (inside the car) while our invention will allow the car to operate and start—only when the actual human is touching the steering wheel with the secondary key-device sending the signal through the human body.

FIG. 1:

1-2-3-4 : Possible metallic or conductive contact points to receive signal through human body from the secondary key-device
Note: signal may also be received without the use of specific contact points

5—Mobile phone

FIG. 2:

1-3: Secondary key-device emits signal through human body

2 Mobile device (phone)

4: Human skin/body acting as transmitter
It is important to note that pioneering work has already been done in using the human body as a transmitter. The following technology references serve to confirm the viability of the proposed method,

Possible technology to be used by a company known as NTT: http://www.taipeitimes.com/News/biz/archives/2005/03/20/2003247076 this method is called: RedTacton

NTT is not the first company to use the human body as a conduit for data: IBM pioneered the field in 1996 with a system that could transfer small amounts of data at very low speeds, and Microsoft was been granted a series of U.S. Pat. Nos. 6,754,472; 7,480,492 and 8,064,953 all for “a method and apparatus for transmitting power and data using the human body.”

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method to activate and restrict control of a device, comprising:
positioning a secondary device on a human body which generates an authorization key; and
using the human body as a local transmitter to transmit the authorization key from the secondary device to the device which is to be activated and controlled.
